(19) United States
(12) Patent Application Publication
(10) Pub. No.: US 2014/0370430 A1
(43) Pub. Date: Dec. 18, 2014

(54) LOW COST, LOW MELT EMULSION AGGREGATION HIGH GLOSS TONERS WITH LOW MELT WAXES

(71) Applicant: Xerox Corporation, Norwalk, CT (US)

(72) Inventors: Grazyna E. KMIECIK-LAWRYNOWICZ, Fairport, NY (US); Samir KUMAR, Pittsford, NY (US); Robert D. BAYLEY, Fairport, NY (US); Maura A. SWEENEY, Irondequoit, NY (US)

(21) Appl. No.: 13/917,014

(22) Filed: Jun. 13, 2013

(51) Int. Cl. G03G 9/093

(52) U.S. Cl. CPC G03G 9/09364
USPC 430/108.4; 430/111.1; 430/108.8; 430/110.2; 430/108.1; 430/108.7; 430/108.6; 430/137.14

(57) ABSTRACT

A toner particle includes a core containing a styrene-based resin; a low melting point wax; optionally an additive package; and optionally a colorant, wherein the low melting point wax has a melting point of less than about 80° C. A method of making a toner particle includes forming a slimy by mixing together an emulsion containing a resin, a low melting point wax, optionally a colorant, optionally a surfactant, optionally a coagulant, and one or more additional optional additives; and heating the slurry to form aggregated particles in the slurry, wherein the aggregated particles form a core of the toner particles; and the low melting point wax has a melting point of less than about 80° C.

### TECHNICAL FIELD

The present disclosure is generally related to toner compositions, and more specifically, to toner particles having a core containing a low melting point wax.

### BACKGROUND

Toner compositions may be prepared by numerous processes, including emulsion aggregation (EA). Emulsion aggregation techniques may involve a batch or semi-continuous emulsion polymerization, as disclosed in, for example, U.S. Pat. No. 5,853,943, the entire disclosure of which is totally incorporated herein by reference.

Many documents produced by using such a toner composition, and especially, color documents, have a need for a uniform, high gloss. Gloss is the property of a substrate surface which involves specular reflection. Specular reflection is a sharply defined light beam resulting from reflection off a smooth, uniform surface. Gloss follows the law of reflection which states that when a ray of light reflects off a surface, the angle of incidence is equal to the angle of reflection. Gloss properties are generally measured in Gardner Gloss Units (ggu). Gloss varies due to various factors, including paper properties, toner properties and toner mass per unit area (TMA), oil levels, fuser roll age, and temperature variability.

Current emulsion aggregation high gloss (EAHG) low melt toners enable low fusing, but are very expensive. Thus, there is a need for toner formulations that offer low melt performance at significantly reduced costs.

### SUMMARY

Provided is a toner particle comprising a core comprising a styrene-based resin; a low melting point wax; optionally an additive package; and optionally a colorant, wherein the low melting point wax has a melting point of less than about 80° C.

Also provided is a method of making toner particles comprising forming a slurry by mixing together an emulsion containing a resin, a low melting point wax, optionally a colorant, optionally a surfactant, optionally a coagulant, and one or more additional optional additives; and heating the slurry to form aggregated particles in the slurry, wherein the aggregated particles form a core of the toner particles; and the low melting point wax has a melting point of less than about 80° C.

Additionally provided is a composition comprising toner particles comprising a core comprising a styrene-based resin; a low melting point wax selected from the group consisting of a paraffin wax and an ester wax; optionally a colorant; and optionally an additive package comprising a charge control agent selected from the group consisting of 3,5 Di-tert-butylsalicylic acid, zinc, and aluminum salt, and a surface additive selected from the group consisting of titanium oxide, silicon oxide, tin oxide, colloidal and amorphous silicas, metal salts, polymers, cross-linked polymers, zinc stearate, aluminum oxides, cerium oxides, and mixtures thereof; and a shell surrounding the core, wherein the low melting point wax has a melting point of less than about 80° C.; the low melting point wax is present in the core in an amount of from about 5 to about 20 wt % based on a total weight of the core; the shell has a higher glass transition temperature Tg than the core; the toner particles have an average glass transition temperature Tg of less than about 51° C.; the toner particles have a minimum fusing temperature of less than about 210° C., the toner particles have a gloss of at least about 20 ggu; the toner particles have a melt flow index of from about 25 to about 200 g/10 min; the toner composition has a weight average molecular weight Mw of from about 25,000 pse to about 40,000 pse; the toner composition has a number average molecular weight Mn of from about 12,000 pse to about 15,000 pse; a ratio MWD of the Mw to the Mn of the toner composition is from about 2.00 to about 2.30; and a z-average molecular weight Mz of the toner composition is from about 60,000 to about 80,000.

### EMBODIMENTS

In this specification and the claims that follow, singular forms such as “a,” “an,” and “the” include plural forms unless the content clearly dictates otherwise. All ranges disclosed herein include, unless specifically indicated, all endpoints and intermediate values. In addition, reference may be made to a number of terms that shall be defined as follows:

“Optional” or “optionally” refer, for example, to instances in which subsequently described circumstances may or may not occur, and include instances in which the circumstance occurs and instances in which the circumstance does not occur.

The phrases “one or more” and “at least one” refer, for example, to instances in which one of the subsequently described circumstances occurs, and to instances in which more than one of the subsequently described circumstances occurs.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

“Room temperature” refers to a temperature of from about 20° C. to about 30° C., such as from about 20° C. to about 24° C., or from about 23° C. to about 27° C., or from about 26° C. to about 30° C.

“Low melting point wax” refers to a wax having a melting point of less than about 80° C., such as less than about 75° C., or less than about 70° C., or from about 60° C. to about 80° C., such as from about 60° C. to about 74° C., or from about 72° C. to about 76° C., or from about 75° C. to about 80° C.

“High gloss” refers to images having a gloss measured at about 50 ggu or more, such as about 55 ggu or more, or about 60 ggu or more.

A toner of this disclosure comprises toner particles having a core containing an acrylate resin, a low melting point wax, and an optional colorant. Thus, the low melting point wax is incorporated into, and is part of, the core of the toner particle. The core may be surrounded by a shell Incorporating a low melting point wax into the core of a toner particle lowers the glass transition temperature Tg of the toner and, as a result, the toner has low melt properties.

### Core

Any resin suitable for preparing a latex for use in a toner may be used in preparing the core. Suitable resins include acrylate resins.

Any styrene-based resin may be used in making the latexes. For example, suitable monomers for making the resin include styrenes, acrylates, methacrylates, butadienes, isoprenes, acrylic acids, methacrylic acids, acrylonitriles, combinations thereof, and the like. The resin may be an styrene-based resin, such as those described in U.S. Patent Application Publication No. 2013/0101935

The latex polymer may include a single polymer or a mixture of polymers. Suitable polymers include styrene acrylates, styrene butadienes, styrene methacrylates, and more specifically, poly(styrene-alkyl acrylate), poly(styrene-1,3-diene), poly(styrene-alkyl methacrylate), poly (styrene-alkyl acrylate-acrylic acid), poly(styrene-1,3-diene-acrylic acid), poly (styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly (styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly (methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly (styrene-butadiene-acrylic acid), poly(styrene-butadiene-methacrylic acid), poly (styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and combinations thereof. The polymers may be block, random, or alternating copolymers.

If the polymer is not formed as an emulsion, the emulsion aggregation (EA) process requires polymers to be first formulated into latex emulsions, for example, by solvent containing batch processes, such as solvent flash emulsification and/or solvent-based phase inversion emulsification.

### Low Melting Point Waxes

The core may include either a single type of low melting point wax or a mixture of two or more waxes. When included, the wax may be present in an amount of, for example, from about 1 to about 25 wt % of the core, from about 2 to about 25 wt %, from about 5 to about 20 wt %, or from about 8 to about 15 wt %.

Suitable low melting point waxes include ester waxes; stearyl stearamide; behenyl behenamide; stearyl behenamide; behenyl stearamide; oleyl oleamide; oleyl stearamide; stearyl oleamide; stearyl erucamide; oleyl palmitamide; methylol amides, such as methylol stearamide or methylol behenamide; polyolefin waxes, such as polyethylene waxes, including linear polyethylene waxes and branched polyethylene waxes; polypropylene waxes, including linear polypropylene waxes and branched polypropylene waxes; paraffin waxes; Fischer-Tropsch waxes; amine waxes; silicone waxes; mercapto waxes; polyester waxes; urethane waxes; polyolefin waxes, modified polyolefin waxes, such as a carboxylic acid-terminated polyethylene wax or a carboxylic acid-terminated polypropylene wax; amide waxes, such as aliphatic polar amide functionalized waxes; aliphatic waxes consisting of esters of hydroxylated unsaturated fatty acids; high acid waxes, such as high acid montan waxes; microcrystalline waxes, such as waxes derived from distillation of crude oil; and the like.

The low melting point waxes may have a melt temperature (Tm second heat) of from about 65° C. to about 95° C., such as from about 70° C. to about 90° C., or from about 73° C. to about 85° C., or from about 74° C. to about 80° C. .

### Shell

While not required, the toner particles may further comprise a shell surrounding the core of the toner particles. The shell may be applied to the core of the toner particles by any method within the purview of those skilled in the art. For example, the shell resin may be in an emulsion including any surfactant described below. The aggregated particles described above may be combined with the emulsion so that the resin forms a shell over the formed aggregates. The shell latex may also be applied by, for example, dipping, spraying, and the like. The shell latex may be applied until the desired final size of the toner particles is achieved. For example, the final size of the toner particles may be from about 2 to about 15 μm, such as from about 3 to about 10 μm, or from about 3.5 to about 8 μm.

Any monomer suitable for preparing a latex for use in a toner may be used in preparing the shell. Specifically, the monomers listed above for use in making the core may also be used in making the shell. Additional suitable resins for forming the shell include polyester resin, such as described in U.S. Pat. Nos. 6,593,049 and 6,756,176, the disclosures of each of which are hereby incorporated by reference in their entirety. Suitable resins also include a mixture of an amorphous polyester resin and a crystalline polyester resin as described in U.S. Pat. No. 6,830,860, the disclosure of which is hereby incorporated by reference in its entirety.

When a shell is applied to the core of the toner particles, the shell latex may be added in an amount of from about about 20 to about 40 wt % of the dry toner particle, such as from about 26 to about 36 wt %, or from about 28 to about 34 wt %.

### Colorants

Suitable colorants or pigments include pigment, dye, mixtures of pigment and dye, mixtures of pigments, mixtures of dyes, and the like. For simplicity, the term “colorant” refers to colorants, dyes, pigments, and mixtures, unless specified as a particular pigment or other colorant component. The colorant may comprise a pigment, a dye, mixtures thereof, carbon black, magnetite, black, cyan, magenta, yellow, red, green, blue, brown, and mixtures thereof, in an amount of about 0.1 to about 35 wt % based upon the total weight of the composition, such as from about 1 to about 25 wt %.

Suitable colorants include those known in the art, such as those disclosed in, for example, U.S. Pat. No. 8,192,913, the entire disclosure of which is totally incorporated herein by reference. The colorant may be present in the toner in an amount ranging from about 1 to about 35 wt % of the toner particles on a solids basis, such as from about 5 to about 25 wt %, or from about 3 to about 15 wt %.

### Additives

Suitable toner particle additives include any additive that enhances the properties of the toner composition. For example, the toner may include positive or negative charge control agents. Other additives include organic spacers, color enhancers, and other known toner additives. Surface additives that can be added to the toner compositions after washing or drying include, for example, metal salts, metal salts of fatty acids, colloidal silicas, metal oxides, strontium titanates, combinations thereof, and the like, which additives may each be present in an amount of from about 0.1 to about 10 wt % of the toner particles, such as from about 0.5 to about 7 wt %. Examples of such additives include, for example, those disclosed in U.S. Pat. Nos. 3,590,000; 3,720,617; 3,655,374; and 3,983,045, the entire disclosures of which are totally incorporated herein by reference. Other additives include zinc stearate and AEROSIL R972® available from Degussa. The coated silicas of U.S. Pat. Nos. 6,190,815 and 6,004,714, the entire disclosures of which are totally incorporated herein by reference, may also be selected in amounts, for example, of from about 0.05 to about 5 wt % of the toner particles, such as from about 0.1 to about 2 wt %. These additives may be added during the aggregation or blended into the formed toner product.

Additional suitable additives include those disclosed in U.S. Pat. No. 8,394,562, the entire disclosure of which is totally incorporated herein by reference.

### Surfactants

Colorants, waxes, and other additives used to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered.

One, two, or more surfactants may be used. Suitable surfactants include ionic or nonionic surfactants. Anionic surfactants and cationic surfactants are encompassed by the term “ionic surfactants.” The surfactant may be used so that it is present in an amount of from about 0.01 to about 15 wt % of the toner composition, for example from about 0.75 to about 4 wt % of the toner composition, or from about 1 to about 3 wt % of the toner composition.

Suitable nonionic surfactants include, for example, alcohols, acids and ethers, for example, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™, and ANTAROX 897™. Other examples of suitable nonionic surfactants include a block copolymer of polyethylene oxide and polypropylene oxide, including those commercially available as SYNPERONIC PE/F or SYNPERONIC PE/F 108.

Suitable anionic surfactants include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include DOWFAX™2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be used.

Examples of suitable cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, cetyl pyridinium bromide halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

The choice of particular surfactants or combinations thereof, as well as the amounts of each to be used, are within the purview of those skilled in the art.

### Initiators

Initiators may be added for formation of the latex polymer. Suitable initiators include water soluble initiators, such as ammonium persulfate, sodium persulfate and potassium persulfate, and organic soluble initiators including organic peroxides and azo compounds including Vazo peroxides, such as VAZO 64™, 2-methyl 2-2′-azobis propanenitrile, VAZO 88™, 2-2′- azobis isobutyramide dehydrate, and combinations thereof. Additional water-soluble initiators include azoamidine compounds, for example 2,2′. azobis(2-methyl-N-phenylpropionamidine) dihydrochloride, 2,2′-azobis[N-(4-chlorophenyl)-2-methylpropionamidine] di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis {2-[1-(2-hydroxyethyl)-2-imidazolin-2-yl]propane}dihydrochloride, combinations thereof, and the like.

Initiators may be added in any suitable amount, such as, from about 0.1 to about 8 wt % of the monomers, from about 0.2 to about 5 wt %, or from about 0.3 to 4 wt %.

### Chain Transfer Agents

Chain transfer agents may also be used in forming the latex polymer. Suitable chain transfer agents include dodecane thiol, octane thiol, carbon tetrabromide, and the like, or combinations thereof. The charge transfer agents may be added in any suitable amount, for example from about 0.1 to about 10 wt % of the monomers, from about 0.2 to about 5 wt %, or from about 0.3 to about 4 wt %. The charge transfer agents control the molecular weight properties of the latex polymer when emulsion polymerization is conducted.

### Toner Preparation

The toner particles may be prepared by any method within the purview of one skilled in the art. For example, toners may be prepared by combining a latex polymer binder, a low melting point wax, an optional colorant, and other optional additives. Although emulsion-aggregation processes are described below, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. Toner compositions and toner particles may be prepared by aggregation and coalescence processes in which small-size resin particles are aggregated to the appropriate toner particle size and then coalesced to achieve the final toner-particle shape and morphology.

In the emulsion polymerization process, the reactants may be added to a suitable reactor, such as a mixing vessel. The appropriate amount of at least one monomer, for example, from one to about ten monomers, low melting point wax, surfactant(s), optional functional monomer, optional initiator, optional chain transfer agent, and the like, may be combined in the reactor and the emulsion polymerization process may be initiated. Reaction conditions selected for effecting the emulsion polymerization include temperatures of, for example, from about 45° C. to about 120° C., such as from about 60° C. to about 90° C., or from about 65° C. to about 85° C.

Polymerization may be continued until the desired size particles are formed. For example, the particles may be from about 40 to about 800 nm in volume average diameter, such as from about 100 to about 400 nm, or from about 140 to about 350 nm, as determined, for example, by a Microtrac UPA150 particle size analyzer.

Toner compositions may be prepared by emulsion-aggregation processes, such as a process that includes aggregating a mixture of the low melting point wax and any other desired or required additives, and emulsions including the resins described above, optionally in surfactants as described above, and then coalescing the aggregate mixture.

An aggregating agent may be added to the mixture. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. The aggregating agent, for example, a polymetal salt, may be in a solution of nitric acid, or other diluted acid solutions, such as sulfuric acid, hydrochloric acid, citric acid, or acetic acid. The aggregating agent may be added to the mixture at a temperature that is below the glass transition temperature (Tg) of the resin.

The aggregating agent may be added to the mixture used to form a toner in an amount of, for example, from about 0.1 to about 0.25 parts per hundred (pph) , from about 0.11 to about 0.20 pph, or from about 0.12 to about 0.18 pph, of the resin in the mixture. This provides a sufficient amount of agent for aggregation. The pH of the resulting mixture may be adjusted by an acid such as, for example, acetic acid, nitric acid, sulfuric acid, hydrochloric acid, citric acid, or the like and optionally combinations thereof. The pH of the mixture may be adjusted to from about 2 to about 8, such as from about 2.5 to about 5.5, or from about 2.5 to about 4.5.

The mixture may be homogenized. If the mixture is homogenized, homogenization may be accomplished by mixing at about 600 to about 8000 revolutions per minute (rpm), for example, from at about 2000 to about 7000 rpm, or at about 4000 to about 6000 rpm. Homogenization may be accomplished by any suitable means, including, for example, an IKA ULTRA TURRAX T50 probe homogenizer.

In order to control aggregation and coalescence of the particles, the aggregating agent may be metered into the mixture over time. For example, the agent may be metered into the mixture over a period of from about 5 to about 240 minutes, from about 20 to about 200 minutes, or from about 10 to about 90 minutes. The addition of the agent may also be done while the mixture is maintained under shearing conditions, for example from about 50 to about 10,000 rpm, from about 100 to about 5,000 rpm, or from about 125 to about 4,500 rpm, and at a temperature that is below the glass transition temperature of the resin as discussed above, for example from about 15° C. to about 90° C., from about 20° C. to about 70° C., or from about 25° C. to about 65° C.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 40° C. to about 100° C., from about 45° C. to about 75° C., or from about 50° C. to about 65° C., and holding the mixture at this temperature for a time from about 30 to about 360 minutes, from about 50 to about 300 minutes, or from about 60 to about 120 minutes, while maintaining stirring, to provide the aggregated particles. A shell is then applied at the end of aggregation. The shell latex may be added in an amount of from about 20 to about 40 wt % of the dry toner particle, such as from about 26 to about 36 wt %, or from about 28 to about 34 wt %. A specific amount of time is allowed for the shell to properly adhere to the core, for a time from about 10 to about 120 minutes, from about 15 to about 90 minutes, or from about 20 to about 60 minutes, while maintaining stirring, to provide the aggregated particles with added shell.

The gloss of a toner may be influenced by the amount of retained metal ion, such as Al³⁺, in the particle. The amount of retained metal ion may be further adjusted by the addition of materials such as EDTA. The amount of retained crosslinker, for example Al3+, in toner particles may be from about 0.1 to about 1 pph, from about 0.25 to about 0.8 pph, or about 0.5 pph.

Once the predetermined desired particle size is reached, then the growth process is halted. The predetermined desired particle size may be within the toner particle size ranges mentioned above.

### Toner Particle Properties

The properties of the toner particles may be determined by any suitable technique and apparatus.

The toner particles may have an average onset glass transition temperature Tg of less than about 51° C., such as less than about 48° C., or less than about 45° C., or from about 35° C. to about 51° C., such as from about 35° C. to about 42° C., or from about 40° C. to about 45° C., or from about 44° C. to about 51° C.

The toner particles may have a minimum fusing temperature (MFT) of from about 130° C. to about 210° C., such as from about 140° C. to about 200° C., or from about 145° C. to about 195° C., or from about 150° C. to about 190° C.

The toner particles may further have a gloss of at least about 10 Gardner gloss units (ggu), such as from about 10 to about 90 ggu, or from about 15 to about 85 ggu, or from about 20 to about 80 ggu.

The melt flow index (MFI) of a toner particle may be determined by any method within the purview of those skilled in the art, such as by using a plastometer. For example, the MFI of the toner may be measured on a Tinius Olsen extrustion plastometer at about 125° C. with about 5 kg load force. Samples may then be dispensed into the heated barrel of the melt indexer, equilibrated for an appropriate time, such as from about 5 min to about 7 min, and then the load force of about 5 kg may be applied to the melt indexer piston. The applied load of the piston forces the molten sample out a predetermined orifice opening. The time for the test may be determined when the piston travels one inch. The melt flow may be calculated by the use of the time, distance, and weight volume extracted during the testing procedure.

The MFI of the toner particles described herein may be from about 25 to about 200 g/10 min, such as from about 35 to about 80 g/10 min, or from about 40 to about 154 g/min, or from about 50 to about 200 g/min at a setting of 130° C. and 5 kg.

The weight average molecular weight Mw of the toner particles may be from about 25,000 to about 40,000 pse, such as from about 25,000 to about 33,000 pse, or from about 31,000 to about 36,000 pse, or from about 35,000 to about 40,000 pse. The number average molecular weight Mn of the toner particles may be from about 10,000 to about 20,000 pse, such as from about 12,000 to about 18,000 pse, or from about 13,000 to about 17,000 pse, or from about 14,000 to about 16,000 pse. Thus, a ratio MWD of the Mw to the Mn of the toner particles may be from about 2.00 to about 2.30, such as from about 2.00 to about 2.10, or from about 2.08 to about 2.19, or from about 2.14 to about 2.30. Additionally, the z-average molecular weight Mz of the toner particles may be from about 60,000 to about 80,000 pse, such as from about 60,000 to about 66,000 pse, or from about 63,000 to about 75,000 pse, or from about 70,000 to about 80,000 pse.

The residual aluminum on the toner particles, as measured by inductively coupled plasma (ICP), may be from about 250 to about 650 ppm, such as from about 275 to about 610 ppm, or from about 250 to about 610 ppm, or from about 225 to about 590 ppm.

The toner particles may have a volume average Geometric Standard Deviation GSDv of from about 1.0 to about 1.25, such as from about 1.0 to about 1.14, or from about 1.10 to about 1.19, or from about 1.16 to about 1.25. The toner particles may have a number average Geometric Standard Deviation GSDn of from about 1.15 to about 1.30, such as from about 1.15 to about 1.22, or from about 1.18 to about 1.26, or from about 1.24 to about 1.30.

The toner particles may have a shape factor of from about 0.965 to about 0.999, such as from about 0.965 to about 0.976, or from about 0.968 to about 0.982, or from about 0.980 to about 0.998.

### EXAMPLES

The following Examples are intended to be illustrative only and are not intended to limit the scope of the present disclosure. Also, parts and percentages are by weight unless otherwise indicated.

### Example 1

### Preparation of a Core or Shell Latex by Semi-Continuous Emulsion Polymerization

A core or shell latex for particle formation was made by semi-continues emulsion polymerization. A representative core latex emulsion was prepared as follows:

A monomer in water emulsion was prepared by agitating a monomer mixture of about 29 parts by weight styrene, about 9.8 parts by weight n-butyl acrylate, about 1.17 parts by weight beta-carboxyethyl acrylate (Beta CEA), and about 0.20 parts by weight 1-dodecanethiol with an aqueous solution of about 0.77 parts by weight of DOWFAX™ 2A1 (an alkyldiphenyloxide disulfonate surfactant from Dow Chemical) and about 18.5 parts by weight of distilled water at about 500 revolutions per minute (rpm) at a temperature of from about 20° C. to about 25° C.

About 0.06 parts by weight of DOWFAX™ 2A1 and about 36 parts by weight of distilled water were charged in an 8 liter jacketed glass reactor fitted with a stainless steel 45° pitch semi-axial flow impeller at about 200 rpm, a thermal couple temperature probe, a water cooled condenser with nitrogen outlet, a nitrogen inlet, internal cooling capabilities, and a hot water circulating bath set at about 83° C., and de-aerated for about 30 minutes while the temperature was raised to about 75° C.

About 1.2 parts by weight of the monomer emulsion described above was then added into the reactor and was stirred for about 10 minutes at about 75° C. An initiator solution prepared from about 0.78 parts by weight of ammonium persulfate in about 2.7 parts by weight of distilled water was added to the reactor over about 20 minutes. Stirring continued for about an additional 20 minutes to allow seed particle formation. The remaining monomer emulsion was then fed into the reactor over a time period of about 190 minutes. After the addition, the latex was stirred at the same temperature for about 3 more hours to complete conversion of the monomer. Latex made by the process of semi-continuous emulsion polymerization resulted in latex particle sizes between 150 nm to 250 nm

### Example 2

### Control Particle with a Paraffin Wax

To a 2 liter jacketed glass lab reactor, about 339 parts by weight of a core latex, which was prepared by the process of semi-continuous emulsion polymerization as described in Example 1, about 77 parts by weight of a Regal 330 pigment dispersion, about 17 parts by weight of a Sun PB 15:3 pigment dispersion (from Sun Chemicals Co.), about 95 parts by weight of a paraffin wax dispersion, and about 754 parts by weight of distilled water were added. The components were mixed by a homogenizer for about 2 minutes at about 4000 rpm. With continued homogenization, a separate mixture of about 4.5 parts by weight of poly(aluminum chloride) (from Asada Co.) in about 30 parts by weight of 0.02 M of HNO₃ solution was added drop-wise into the reactor. After the addition of the poly(aluminum chloride) mixture, the resulting viscous slurry was further homogenized at about 20° C. for about 20 minutes at about 4000 rpm. At this time the homogenizer was removed and replaced with a stainless steel 45° pitch semi-axial flow impeller and stirred continuously at about 350 to 300 rpm, while raising the temperature of the contents of the reactor to about 52° C. The batch was held at this temperature until a core particle size of about 5.3 microns was achieved.

A shell was added to the core by the following process. While stirring continuously at about 300 rpm, about 180 parts by weight of a shell latex, which was prepared by the process of semi-continuous emulsion polymerization described in Example 1, was added drop-wise, over a period of about 10 minutes, to the reactor containing the core particle having a particle size of about 5.3 microns. After the complete addition of the latex, the resulting particle slurry was stirred for about 30 minutes, at which time about 6 parts of tetra sodium salt of ethylenediaminetetraacetic acid and a sufficient amount of 1 molar NaOH was added to the slurry to adjust the pH of the slurry to about 5.7. After the pH adjustment, the stirrer speed was lowered to about 160 rpm for an additional 10 minutes. At the end of the 10 minutes, the bath temperature was adjusted to about 98° C. to heat the slurry to about 96° C. During the temperature increase, the pH of the slurry was adjusted to about 5.3 by the addition of a sufficient amount of a 0.3 M HNO₃ solution at about 80° C. The slurry temperature was then allowed to increase to about 96° C. and was maintained at 96° C. to complete coalescence in about 25 minutes. At this time, a sufficient amount of 1 molar NaOH was added to the particle slurry to adjust the pH to about 6.0, and the slurry was immediately cooled to about 63° C. Upon reaching 63° C., the particle slurry was again pH adjusted with a sufficient amount of 1 molar NaOH to obtain a pH of 8.8, followed by immediate cooling to about 30° C. to 35° C. At this time, the toner particles were collected by filtration, washed several times, and freeze dried to remove water. After washing and drying, the diameter of the resulting toner particles was about 6.1 microns

The resulting particles had an average diameter of 5.8 μm, a GSDv of 1.19, a GSDn of 1.22, and a circularity of 0.968. The glass transition temperature Tg of the particles was 50.3° C., which is lower than the standard glass transition temperature of a comparative EAHG toner prepared with polyethylene wax by an emulsion aggregation process at 54.3° C.

The toner particles were blended in a Fuji mill blender with external additives in the amounts shown below in Table 1.

TABLE 1

| | Percentage |
|---|---|
| Additive | Range |
| Cerium Oxide | 0.50-0.65 |
| JMT 2000 (titania) | 0.80-0.90 |
| RY50 (silica) | 1.65-1.75 |
| X24 (sol-gel silica) | 1.68-1.78 |
| Zinc stereate | 0.1-0.3 |

The toner was then tested. Improvement in the minimum fixing temperature (MFT) and gloss were observed indicating lower melt properties of the toner.

### Example 3

### Control Particle with an Ester Wax

To a 2 liter jacketed glass lab reactor, about 339 parts by weight of a core latex, which was prepared by the process of semi-continuous emulsion polymerization described in Example 1, about 77 parts by weight of a Regal 330 pigment dispersion, about 17 parts by weight of a Sun PB 15:3 pigment dispersion (from Sun Chemicals Co.), about 86 parts by weight of ester wax K-72 wax dispersion, and about 763 parts by weight of distilled water were added. The components were mixed by a homogenizer for about 2 minutes at about 4000 rpm. With continued homogenization, a separate mixture of about 4.5 parts by weight of poly(aluminum chloride) (from Asada Co.) in about 30 parts by weight of 0.02 M of HNO₃ solution was added drop-wise into the reactor. After the addition of the poly(aluminum chloride) mixture, the resulting viscous slurry was further homogenized at about 20° C. for about 20 minutes at about 4000 rpm. At this time the homogenizer was removed and replaced with a stainless steel 45° pitch semi-axial flow impeller, and the slurry was stirred continuously at about 350 to 300 rpm, while raising the temperature of the contents of the reactor to about 50° C. The mixture was held at this temperature until a core particle size of about 5.3 microns was achieved

MIN A shell was added to the core by the following process. While being continuously stirred at about 300 rpm, about 180 parts by weight of a shell latex, which was prepared by the process of semi-continuous emulsion polymerization described in Example 1, was added drop-wise, over a period of about 10 minutes, to the reactor containing the core particle having a particle size of about 5.3 microns. After the complete addition of the latex, the resulting particle slurry was stirred for about 20 minutes, at which time about 6 parts of tetra sodium salt of ethylenediaminetetraacetic acid and a sufficient amount of 1 molar NaOH was added to the slurry to adjust the pH of the slurry to about 5.8. After the pH adjustment, the stirrer speed was lowered to about 160 rpm for an additional 10 minutes. At the end of the 10 minutes, the bath temperature was adjusted to about 98° C. to heat the slurry to about 96° C. During the temperature increase, the pH of the slurry was adjusted to about 5.5 by the addition of a sufficient amount of 0.3 M HNO₃ solution at about 80° C. The slurry temperature was then allowed to increase to about 96° C. and was maintained at about 96° C. to complete coalescence in about 17 minutes. At this time, a sufficient amount of 1 molar NaOH was added to the particle slurry to adjust the pH to about 6.0, and the slurry was immediately cooled to about 63° C. Upon reaching 63° C., the particle slurry was again pH adjusted with a sufficient amount of 1 molar NaOH to obtain a pH of about 8.8, followed by immediate cooling to about 30° C. to 35° C. At this time, the toner particles were collected by filtration, washed several times and freeze dried to remove water. After washing and drying, the diameter of the resulting toner particles was about 5.8 microns.

The resulting particles had an average diameter of 5.8 um, a GSDv of 1.19, a GSDn of 1.22, and a circularity of 0.976. The glass transition temperature Tg of the particles was about 44.3° C., which is lower than the standard glass transition temperature of a comparative EAHG toner prepared with polyethylene wax by an emulsion aggregation process at 54.3° C.

The toner particles were blended in a Fuji mill blender with external additives in the amounts shown above in Table 1.

The toner was then tested. Improvement in the minimum fixing temperature (MFT) and gloss were observed indicating lower melt properties of the toner.

### Example 4

### Scale-up of Example 2

A 20 gallon reactor with an in-line homogenizer was charged with about 13.2 kg by weight of a core latex, which was prepared by the process of semi-continuous emulsion polymerization described in Example 1, combined with about 4.0 kg by weight of a Regal 330 pigment dispersion, about 0.66 kg by weight of a Sun PB 15:3 pigment dispersion (from Sun Chemicals Co.), about 3.8 kg by weight of a paraffin wax dispersion, and about 29.7 kg by weight of distilled water. The mixture was agitated at about 200 rpm. The components, while mixed at about 200 rpm, were homogenized for about 15 minutes at about 4000 rpm. With continued homogenization, a separate mixture of about 0.18 kg by weight of poly(aluminum chloride) (from Asada Co.) in about 1.6 kg by weight of a 0.02 M HNO₃ solution was added to the reactor contents in about 6 minutes. After the addition of the poly(aluminum chloride) mixture, the resulting viscous reactor contents were further homogenized at about 28° C. for a combined total time of about 60 minutes at about 4000 rpm with agitation at about 200 rpm. At this time the homogenization was stopped and the reactor contents continued to be agitated from about 280 to 210 rpm to commence aggregation while raising the temperature of the contents of the reactor to about 52° C. The mixture was held at this temperature until a core particle size of about 4.7 microns was achieved.

A shell was added to the core by the following process. While being continuously stirred at about 210 rpm, about 7.2 kg by weight of shell latex, which was prepared by the process of semi-continuous emulsion polymerization described in Example 1, was added over a period of about 25 minutes to the reactor containing the core particle having a particle size of about 4.7 microns. After the complete addition of the latex, the resulting particle slurry was agitated for about 40 minutes, which resulted in a particle having a particle size of about 5.5 microns. At this time about 0.18 kg of tetra sodium salt of ethylenediaminetetraacetic acid and a sufficient amount of 1 molar NaOH was added to the slurry to adjust the pH of the slurry to about 5.1. After the pH adjustment, the stirrer speed was lowered to about 140 rpm for an additional 10 minutes. At the end of the 10 minutes, the batch temperature was adjusted to about 95° C. During the temperature increase to a batch temperature of 95° C., the pH of the batch was adjusted to about 5.3 by the addition of a sufficient amount of 1 molar NaOH solution at about 80° C. The batch was then maintained at about 95° C. to complete coalescence in about 90 minutes. At this time, a sufficient amount of 1 molar NaOH was added to the particle batch to adjust the pH to about 6.0, and the batch was immediately cooled to about 63° C. Upon reaching 63° C. the particle batch was again pH adjusted with a sufficient amount of 1 molar NaOH to obtain a pH of 8.8, followed by immediate cooling to about 30° C. to 35° C. At this time the toner particles were collected by filtration, washed several times, and air dried by a 2 inch Aljet Dryer to remove water

The average particle diameter of the resulting particles was 5.4 μm. The particles had a GSDv of 1.18, a GSDn of 1.21, and a circularity of 0.976.

The toner particles were blended in a 10 L Henschel blender with the external additives shown in Table 1. The toner was then tested. Improvement in the minimum fixing temperature (MFT) and gloss were observed indicating lower melt properties of the toner.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

1. A toner particle comprising:
a core comprising:
a styrene-based resin;
a low melting point wax;
an additive package; and
a colorant,
wherein the low melting point wax has a melting point of less than about 80° C.; and
a shell surrounding the core, wherein the shell has a higher glass transition temperature Tg than the core:,
wherein the toner particle has a gloss of at least about 20 ggu.

2. The toner particle of claim 1, wherein the low melting point wax is selected from the group consisting of a paraffin wax and an ester wax.

3. The toner particle of claim 1, wherein the low melting point wax is present in the core in an amount from about 5 to about 20 wt % based on a total weight of the core.

4. The toner particle of claim 1, wherein the toner particle has an average glass transition temperature Tg of less than about 51° C.

5. The toner particle of claim 1, wherein the toner particle has a minimum fusing temperature of less than about 170° C.

6. (canceled)

7. (canceled)

8. (canceled)

9. The toner particle of claim 1, wherein the toner particles have a melt flow index of from about 25 to about 200 g/10 min.

10. The toner particle of claim 1, wherein the additive package comprises:
a charge control agent selected from the group consisting of 3,5 Di-tert-butylsalicylic acid, zinc, and aluminum salt; and
a surface additive selected from the group consisting of titanium oxide, silicon oxide, tin oxide, colloidal and amorphous silicas, metal salts, polymers, cross-linked polymers, zinc stearate, aluminum oxides, cerium oxides, and mixtures thereof.

11. A method of making toner particles comprising:
forming a slurry by mixing together an emulsion containing a resin, a low melting point wax, optionally a colorant, optionally a surfactant, optionally a coagulant, and one or more additional optional additives; and
heating the slurry to form aggregated particles in the slurry,
wherein:
the aggregated particles form a core of the toner particles; and
the low melting point wax has a melting point of less than about 80° C.

12. The method of claim 11, wherein the low melting point wax is selected from the group consisting of a paraffin wax and an ester wax.

13. The method of claim 11, wherein the low melting point wax is present in the core in an amount of from about 5 to about 15 wt % based on a total weight of the core.

14. The method of claim 11, wherein the toner particle has an average glass transition temperature Tg of less than about 51° C.

15. The method of claim 11, wherein the toner particle has a minimum fusing temperature of less than about 210° C.

16. The method of claim 11, further comprising forming a shell surrounding the core.

17. The method of claim 16, wherein the shell has a higher glass transition temperature Tg than the core.

18. The method of claim 11, wherein the toner particle has a gloss of at least about 25 ggu.

19. The toner particle of claim 11, wherein the one or more optional additives comprise:
a charge control agent selected from the group consisting of 3,5 Di-tert-butylsalicylic acid, zinc, and aluminum salt; and
a surface additive selected from the group consisting of titanium oxide, silicon oxide, tin oxide, colloidal and amorphous silicas, metal salts, polymers, cross-linked polymers, zinc stearate, aluminum oxides, cerium oxides, and mixtures thereof.

20. A composition comprising toner particles comprising:
a core comprising:
a styrene-based resin;
a low melting point wax selected from the group consisting of a paraffin wax and an ester wax;
a colorant; and
an additive package comprising:
a charge control agent selected from the group consisting of 3,5 Di-tert-butylsalicylic acid, zinc, and aluminum salt, and
a surface additive selected from the group consisting of titanium oxide, silicon oxide, tin oxide, colloidal and amorphous silicas, metal salts, polymers, cross-linked polymers, zinc stearate, aluminum oxides, cerium oxides, and mixtures thereof; and
a shell surrounding the core, the shell comprising a wax that is different than the low melting point wax,
wherein:
the low melting point wax has a melting point of less than about 80° C.;
the low melting point wax is present in the core in an amount of from about 5 to about 20 wt % based on a total weight of the core;
the shell has a higher glass transition temperature Tg than the core;
the toner particles have an average glass transition temperature Tg of less than about 51° C.;
the toner particles have a minimum fusing temperature of less than about 200° C.;
the toner particles have a gloss of at least about 30 ggu;
the toner particles have a melt flow index of from about 15 to about 200 g/10 min;
the toner composition has a weight average molecular weight Mw of from about 25,000 pse to about 40,000 pse;
the toner composition has a number average molecular weight Mn of from about 12,000 pse to about 15,000 pse;
a ratio MWD of the Mw to the Mn of the toner composition is from about 2.00 to about 2.30; and
a z-average molecular weight Mz of the toner composition is from about 60,000 to about 80,000.
